(19) United States
(12) Patent Application Publication
(10) Pub. No.: US 2017/0126109 A1
(43) Pub. Date: May 4, 2017

(54) VIBRATION MOTOR

(71) Applicant: Nidec Corporation, Kyoto (JP)

(72) Inventor: Kenji HARA, Kyoto (JP)

(21) Appl. No.: 15/335,478

(22) Filed: Oct. 27, 2016

(30) Foreign Application Priority Data
Oct. 30, 2015 (JP) 2015-214645

(51) Int. Cl. H02K 33/00

(52) U.S. Cl. CPC H02K 33/00

(57) ABSTRACT

A vibration motor includes a stationary portion including a housing and a coil, a moving portion, and an elastic member arranged between the stationary portion and the moving portion. The moving portion includes a magnet, a bracket, and an adhesive layer. The moving portion further includes a jacket arranged to cover at least a portion of a side surface of the adhesive layer. The coverage of at least a portion of the adhesive layer with the jacket contributes to preventing damage to the magnet and the adhesive layer when a load is applied to the moving portion. This contributes to preventing damage to the moving portion while minimizing an increase in the size of the vibration motor.

### CROSS REFERENCE TO RELATED APPLICATIONS

This application claims the benefit of priority to Japanese Patent Application No. 2015-214645 filed Oct. 30, 2015. The entire contents of this application is hereby incorporated herein by reference.

### BACKGROUND OF THE INVENTION

1. Field of the Invention

The present invention relates to a vibration motor.

2. Description of the Related Art

Vibration generation devices that generate vibrations using a magnetic field are known. Such vibration generation devices are used in, for example, portable terminals, such as cellular phones, game machines, toys, and so on. Vibration generation devices having various mechanisms have been developed up to the present. Examples include a rotating vibration motor that, when driven, generates vibrations with an eccentric weight attached to a rotating shaft of the motor, and a linear vibration motor that causes reciprocating vibrations of a vibrator using magnetic fields generated by a coil and a magnet.

It is difficult to reduce the thickness of the rotating vibration motor, and the rotating vibration motor has poor durability and may generate noise when used for a long time. Meanwhile, it is easier to reduce the thickness of the linear vibration motor than the thickness of the rotating vibration motor. A known linear vibration motor is described in, for example, CN 102611272A.

However, in the vibration motor described in CN 102611272A, a magnet is surrounded by a mass body, and this makes it difficult to reduce the size of the vibration motor while the rigidity of a moving body including the magnet is improved. If the mass body were omitted, it would be possible to reduce the size of the vibration motor, but the moving body including the magnet would be easily damaged when a load, such as an exterior shock, is applied to the vibration motor.

### SUMMARY OF THE INVENTION

A vibration motor according to a preferred embodiment of the present invention includes a stationary portion including a housing and at least one coil; a moving portion supported to be capable of oscillating in an oscillation direction with respect to the stationary portion; and an elastic member arranged between the stationary portion and the moving portion. The at least one coil, the moving portion, and the elastic member are accommodated in the housing. The moving portion includes: a magnet arranged opposite to the at least one coil; brackets arranged at both ends of the magnet with respect to the oscillation direction; and at least one adhesive layer arranged to adhere and fix members adjacent to each other in the oscillation direction to each other. The moving portion further includes a jacket arranged to cover at least a portion of a side surface of the at least one adhesive layer.

According to the above preferred embodiment of the present invention, the likelihood that the moving portion including the magnet will be damaged when a load is applied to the moving portion is reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an exploded perspective view of a vibration motor according to a first preferred embodiment of the present invention.

FIG. 2 is a top view of the vibration motor according to the first preferred embodiment of the present invention with a cover portion removed therefrom.

FIG. 3 is an exploded perspective view of a vibration motor according to a second preferred embodiment of the present invention.

FIG. 4 is an exploded perspective view of a vibration motor according to a third preferred embodiment of the present invention.

FIG. 5 is an exploded perspective view of a vibration motor according to a fourth preferred embodiment of the present invention.

FIG. 6 is a top view of a vibration motor according to a fifth preferred embodiment of the present invention with a cover portion removed therefrom.

FIG. 7 is a top view of a vibration motor according to a sixth preferred embodiment of the present invention with a cover portion removed therefrom.

FIG. 8 is an exploded perspective view of a vibration motor according to a seventh preferred embodiment of the present invention.

FIG. 9 is an exploded perspective view of a vibration motor according to an eighth preferred embodiment of the present invention.

FIG. 10 is a top view of the vibration motor according to the eighth preferred embodiment of the present invention with a cover portion removed therefrom.

### DETAILED DESCRIPTION OF THE PREFERRED EMBODIMENTS

Hereinafter, vibration motors according to preferred embodiments of the present invention will be described. It is assumed in the present disclosure that a direction in which a moving portion oscillates is referred to as an “oscillation direction”. It is also assumed in the present disclosure that a side on which a cover portion is arranged with respect to a body portion of a housing is an upper side in a vertical direction. Note that the oscillation direction is a horizontal direction perpendicular to the vertical direction. In addition, a direction perpendicular to both the vertical direction and the oscillation direction is referred to as a lateral direction. It should be noted, however, that the above definitions of the directions are not meant to restrict in any way the orientation of a vibration motor at the time of manufacture or when in use.

### 1. First Preferred Embodiment

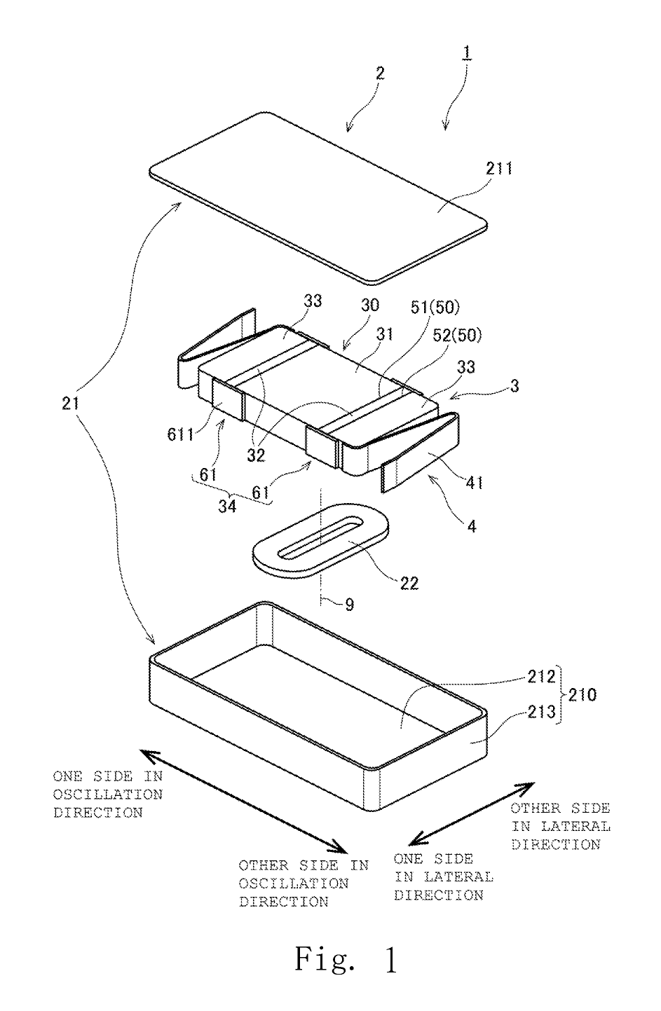

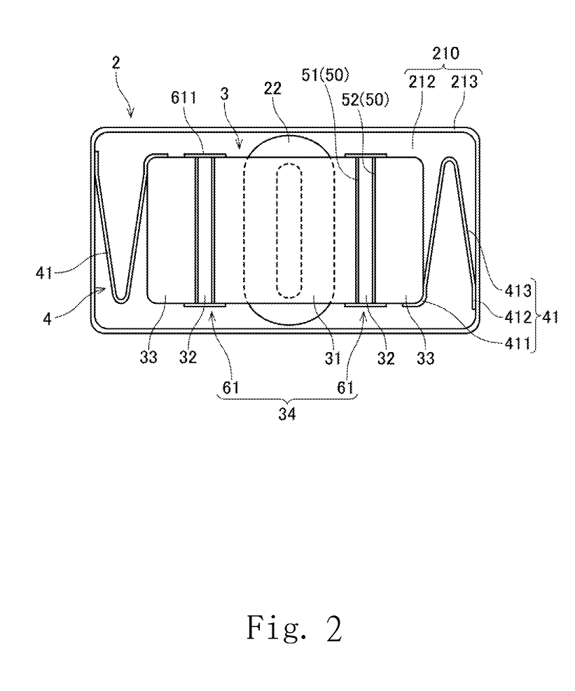

FIG. 1 is an exploded perspective view of a vibration motor 1 according to a first preferred embodiment of the present invention. FIG. 2 is a top view of the vibration motor 1 with a cover portion 211 removed therefrom. The vibration motor 1 is a device arranged to generate vibrations, and incorporated in a portable terminal, such as, for example, a cellular phone. As illustrated in FIGS. 1 and 2, the vibration motor 1 includes a stationary portion 2, a moving portion 3, and elastic members 4.

The stationary portion 2 includes a housing 21, a coil 22, and a circuit board (not shown). The moving portion 3 includes a magnet 31, a pair of brackets 32, two weights 33, and a jacket 34. Each elastic member 4 is arranged between the stationary portion 2 and the moving portion 3. The moving portion 3 is thus supported to be capable of oscillating in the oscillation direction with respect to the stationary portion 2.

The housing 21 is made up of two members: a body portion 210 and the cover portion 211. The body portion 210 includes a bottom portion 212 arranged to extend horizontally, and a wall portion 213 arranged to extend upward from the bottom portion 212 to assume a tubular shape. The cover portion 211 is arranged to cover an upper opening of the body portion 210.

The coil 22, which is attached to the bottom portion 212, the moving portion 3, which is arranged above the coil 22, and the elastic members 4, which are arranged to support the moving portion in relation to the wall portion 213 of the housing 21, are accommodated in the housing 21.

The coil 22 is an air-core spiral coil formed by a conducting wire wound in a flat and spiral pattern to form a space in the center thereof. Portions of the conducting wire extending from the coil 22 are connected to the circuit board. The coil 22 is wound about an axis 9 extending in the vertical direction, which is substantially perpendicular to the oscillation direction. The coil 22 is arranged below the magnet 31. That is, the coil 22 is arranged on one axial side of the magnet 31.

The magnet 31 is substantially in the shape of a rectangular parallelepiped, and is polarized in the oscillation direction. That is, two end surfaces of the magnet 31 with respect to the oscillation direction are a north pole surface and a south pole surface. The magnet 31 is arranged in such a manner that a lower surface thereof is opposed to an upper surface of the coil 22.

The pair of brackets 32 are arranged at both ends of the magnet 31 with respect to the oscillation direction. Each of the brackets 32 according to the present preferred embodiment is a plate-shaped member arranged to extend substantially perpendicularly to the oscillation direction. In addition, the pair of brackets 32 are arranged to cover the entire end surfaces of the magnet 31 with respect to the oscillation direction.

Each weight 33 is arranged adjacent to a separate one of the brackets 32 in the oscillation direction. The weights 33 are arranged at both ends of a moving body 30 made up of the magnet 31, the brackets 32, and the weights 33 with respect to the oscillation direction. As a material of each weight 33, a metal having a specific gravity greater than that of each bracket 32, for example, is used. Arranging the weights 33 at end portions of the moving body 30 with respect to the oscillation direction leads to increasing vibration energy of the moving body 30.

As illustrated in FIG. 2, the magnet 31 and each bracket 32, which are adjacent to each other in the oscillation direction, are adhered and fixed to each other through an adhesive layer 50, and each bracket 32 and the weight 33 adjacent thereto in the oscillation direction are adhered and fixed to each other through an adhesive layer 50. That is, each adhesive layer 50 is arranged to adhere and fix members adjacent to each other in the oscillation direction to each other. The adhesive layers 50 include first adhesive layers 51 and second adhesive layers 52. Each first adhesive layer 51 is arranged between the magnet 31 and the bracket 32 adjacent to each other in the oscillation direction to fix the magnet 31 and the bracket 32 to each other. Each second adhesive layer 52 is arranged between the bracket 32 and the weight 33 adjacent to each other in the oscillation direction to fix the bracket 32 and the weight 33 to each other.

The jacket 34 is a member arranged to cover at least a portion of a side surface of each adhesive layer 50. Here, the side surface of each adhesive layer 50 refers to upper and lower end surfaces and lateral end surfaces of the adhesive layer 50. The jacket 34 is defined by, for example, plate-shaped metallic members. As a material of the jacket 34, a material having a rigidity higher than that of the magnet 31 is used. Note that another material, such as, for example, a resin, may alternatively be used as the material of the jacket 34. A material having a rigidity higher than those of the magnet 31, the brackets 32, and the weights 33 is preferably used as the material of the jacket 34.

If a load is applied to the moving body 30, in which the members thereof are fixed to one another through the adhesive layers 50, in a direction perpendicular to the oscillation direction, a particular stress is applied to each adhesive layer 50 and its vicinity. Accordingly, if the moving portion 3 did not have the jacket 34, end portions of the magnet 31 with respect to the oscillation direction and their vicinity and the adhesive layers 50 might be easily damaged. However, in the vibration motor 1, at least a portion of the side surface of each adhesive layer is covered with the jacket 34, and this contributes to preventing damage to the adhesive layer 50. The structure of the jacket 34 will be described in detail below.

Each elastic member 4 is arranged between the stationary portion 2 and the moving portion 3 to support the moving portion 3 such that the moving portion 3 is capable of oscillating with respect to the stationary portion 2. The elastic members 4 according to the present preferred embodiment are a pair of plate springs 41. Each plate spring 41 is defined by a plate-shaped member extending in the vertical direction. Each plate spring 41 includes a first fixing portion 411, a second fixing portion 412, and an elastic portion 413.

The first fixing portion 411 is a portion substantially in the shape of the letter “L” when viewed in the vertical direction. The first fixing portion is fixed to an end surface of the moving body 30 with respect to the oscillation direction and a lateral side surface of the moving body 30. The second fixing portion 412 is a portion extending in the lateral direction. The second fixing portion 412 is fixed to an inner surface of the wall portion 213 of the housing 21. The elastic portion 413 is a portion substantially in the shape of the letter “V” when viewed in the vertical direction. The elastic portion 413 is capable of expanding and contracting in the oscillation direction.

If an electric drive current is supplied to the coil 22 of the vibration motor 1 as described above, a magnetic field generated by the coil 22 and a magnetic field generated by the magnet 31 interact to cause a Lorentz force to act on the magnet 31. The moving portion 3 is thus caused to oscillate in the oscillation direction.

As illustrated in FIGS. 1 and 2, the jacket 34 according to the present preferred embodiment is arranged to cover portions of the side surface of each of the first and second adhesive layers 51 and 52. This coverage of the portions of the side surface of each of the adhesive layers 51 and 52 with the jacket 34 contributes to preventing damage to the magnet 31 and the adhesive layers 50 when a load is applied to the moving body 30 in a direction substantially perpendicular to the surface covered with the jacket 34.

The jacket 34 includes two lateral surface covering portions 61. Each lateral surface covering portion 61 includes a pair of first plate-shaped portions 611 each of which extends in the oscillation direction and which are arranged opposite to each other with the adhesive layers 50 therebetween. Each first plate-shaped portion 611 covers the adhesive layers 50 and at least portions of the members adjacent to each adhesive layer 50 which extend in the oscillation direction.

Each first plate-shaped portion 611 covers, on one lateral side surface of the moving body 30, a portion of the magnet 31 which extends in the oscillation direction, the first adhesive layer 51, the bracket 32, the second adhesive layer 52, and a portion of the weight 33 which extends in the oscillation direction. Thus, each lateral surface covering portion 61 covers both lateral side surfaces of each of the first adhesive layer 51 and the second adhesive layer 52. This contributes to more effectively preventing damage to the magnet 31, the first adhesive layer 51, and the second adhesive layer 52 when a load is applied to the moving body 30 in the vertical direction or in the lateral direction. This in turn contributes to preventing damage to the moving body 30 including the magnet 31. Note that, in the present preferred embodiment, the lateral side surfaces of the moving body 30 are covered with the jacket 34, and therefore, prevention of damage to the moving body 30 is particularly effective against a load applied to the moving body 30 in the lateral direction.

Each first plate-shaped portion 611 according to the present preferred embodiment is fixed to the side surface of the moving body 30 through adhesion. The first plate-shaped portion 611 is adhered and fixed to the adhesive layers 50 and the two members adjacent to each of the adhesive layers 50. The jacket 34 is preferably fixed to both the two members having the adhesive layer 50 therebetween as described above. Note that the jacket 34 may alternatively be fixed to the moving body 30 by a method other than adhesion. For example, the jacket 34 may be fixed to the moving body 30 through welding, screwing, crimping, resin molding, or the like.

Although the jacket 34 according to the present preferred embodiment includes the plurality of lateral surface covering portions 61 spaced from each other in the oscillation direction, this is not essential to the present invention. The jacket may alternatively include only one lateral surface covering portion. In this case, each of a pair of first plate-shaped portions of the lateral surface covering portion covers the entire extent of the magnet 31 in the oscillation direction, the two first adhesive layers, the pair of brackets, the two second adhesive layers, and a portion of each of the two weights which extends in the oscillation direction. That is, the jacket covers the entire lateral side surfaces of the magnet, the entire lateral side surfaces of the first adhesive layers, and the entire lateral side surfaces of the second adhesive layers. In this case, the jacket covers the entire extent of the magnet in the oscillation direction on the lateral side surfaces of the magnet, and this contributes to more effectively preventing damage to the magnet.

### 2. Second Preferred Embodiment

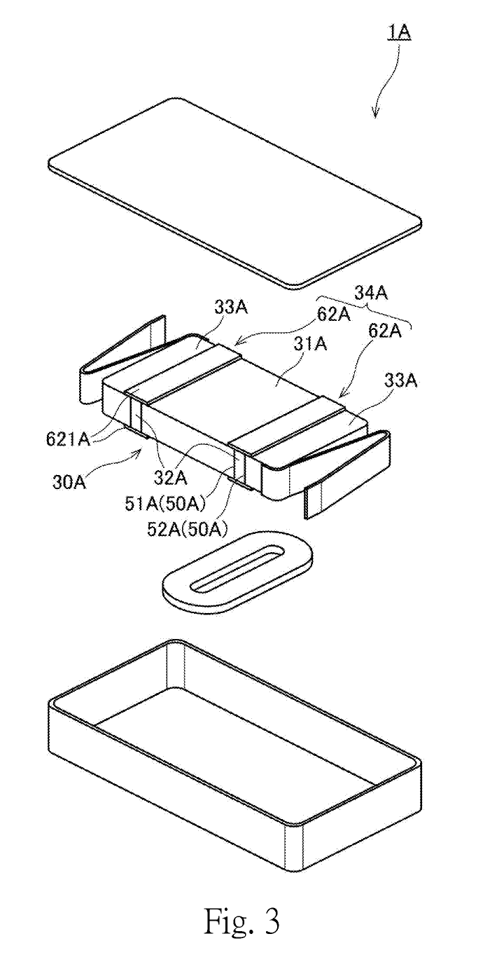

FIG. 3 is an exploded perspective view of a vibration motor 1A according to a second preferred embodiment of the present invention. The vibration motor 1A is different from the vibration motor 1 according to the first preferred embodiment only in the shape of the jacket.

A jacket 34A of the vibration motor 1A is a member arranged to cover at least portions of side surfaces of adhesive layers 50A. The jacket 34A includes two upper/lower surface covering portions 62A. Each upper/lower surface covering portion 62A includes a pair of second plate-shaped portions 621A each of which extends in the oscillation direction and which are arranged opposite to each other with the adhesive layers 50A therebetween. Each second plate-shaped portion 621A covers the adhesive layers 50A and at least portions of members adjacent to each of the adhesive layers 50A which extend in the oscillation direction.

Each second plate-shaped portion 621A covers, on an upper side surface or a lower side surface of a moving body 30A, a portion of a magnet 31A which extends in the oscillation direction, a first adhesive layer 51A, a bracket 32A, a second adhesive layer 52A, and a portion of a weight 33A which extends in the oscillation direction. That is, each upper/lower surface covering portion 62A covers both the upper and lower side surfaces of each of the first adhesive layer 51A and the second adhesive layer 52A. This contributes to more effectively preventing damage to the magnet 31A, the first adhesive layer 51A, and the second adhesive layer 52A when a load is applied to the moving body 30A in the vertical direction or in the lateral direction. This in turn contributes to preventing damage to the moving body 30A including the magnet 31A. Note that, in the present preferred embodiment, the upper and lower side surfaces of the moving body 30A are covered with the jacket 34A, and therefore, prevention of damage to the moving body 30A is particularly effective against a load applied to the moving body 30A in the vertical direction.

Although the jacket 34A according to the present preferred embodiment includes the plurality of upper/lower surface covering portions 62A spaced from each other in the oscillation direction, this is not essential to the present invention. The jacket may alternatively include only one upper/lower surface covering portion. In this case, each of a pair of second plate-shaped portions of the upper/lower surface covering portion covers the entire extent of the magnet 31A in the oscillation direction, the two first adhesive layers, the pair of brackets, the two second adhesive layers, and a portion of each of the two weights which extends in the oscillation direction. That is, the jacket covers the entire upper and lower side surfaces of the magnet, the entire upper and lower side surfaces of the first adhesive layers, and the entire upper and lower side surfaces of the second adhesive layers. In this case, the jacket covers the entire extent of the magnet in the oscillation direction on the upper and lower side surfaces of the magnet, and this contributes to more effectively preventing damage to the magnet.

### 3. Third Preferred Embodiment

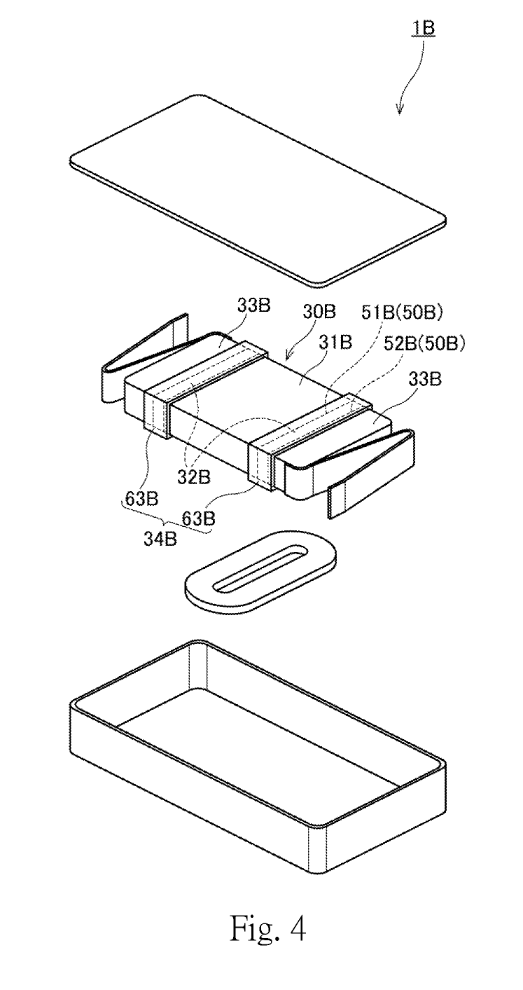

FIG. 4 is an exploded perspective view of a vibration motor 1B according to a third preferred embodiment of the present invention. The vibration motor 1B is different from the vibration motor 1 according to the first preferred embodiment only in the shape of the jacket.

A jacket 34B of the vibration motor 1B is a member arranged to cover side surfaces of adhesive layers 50B. The jacket 34B includes two tubular portions 63B. Each tubular portion 63B extends in the oscillation direction, and annularly covers the side surfaces of the adhesive layers 50B. Each tubular portion 63B covers a portion of a magnet 31B which extends in the oscillation direction, a first adhesive layer 51B, a bracket 32B, a second adhesive layer 52B, and a portion of a weight 33B which extends in the oscillation direction. That is, each tubular portion 63B covers the entire side surface, including the upper and lower side surfaces and lateral side surfaces, of each of the first adhesive layer 51B and the second adhesive layer 52B.

Accordingly, in the case of the vibration motor 1B illustrated in FIG. 4, damage to the magnet 31B, the first adhesive layers 51B, and the second adhesive layers 52B can be more effectively prevented when a load is applied to a moving body 30B either in the vertical direction or in the lateral direction. Accordingly, damage to the moving body 30B including the magnet 31B can be more effectively prevented.

### 4. Fourth Preferred Embodiment

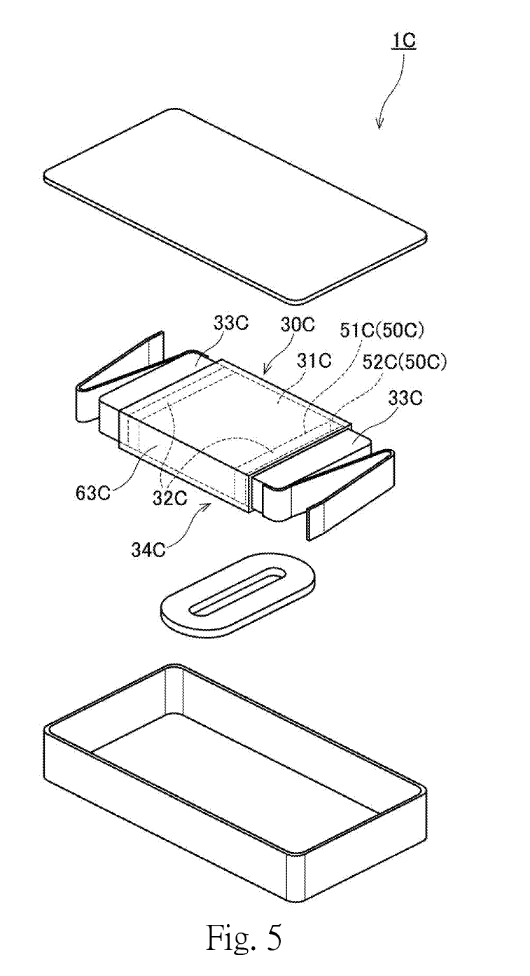

FIG. 5 is an exploded perspective view of a vibration motor 1C according to a fourth preferred embodiment of the present invention. The vibration motor 1C is different from the vibration motor 1 according to the first preferred embodiment only in the shape of the jacket.

A jacket 34C of the vibration motor 1C is a member arranged to cover side surfaces of adhesive layers 50C. The jacket 34C includes one tubular portion 63C. The tubular portion 63C extends in the oscillation direction, and annularly covers the side surfaces of the adhesive layers 50C. The tubular portion 63C covers the entire extent of a magnet 31C in the oscillation direction, two first adhesive layers 51C, a pair of brackets 32C, two second adhesive layers 52C, and a portion of each of two weights 33C which extends in the oscillation direction. That is, the tubular portion 63C covers the entire side surface, including upper and lower side surfaces and lateral side surfaces, of each of the magnet 31C, the first adhesive layers 51C, and the second adhesive layers 52B.

This contributes to more effectively preventing damage to the magnet 31C, the first adhesive layers 51C, and the second adhesive layers 52C when a load is applied to a moving body 30C either in the vertical direction or in the lateral direction. This in turn contributes to more effectively preventing damage to the moving body 30C including the magnet 31C. Further, the jacket 34C covers the entire extent of the magnet 31C in the oscillation direction, and this contributes to more effectively preventing damage to the magnet 31C.

### 5. Fifth Preferred Embodiment

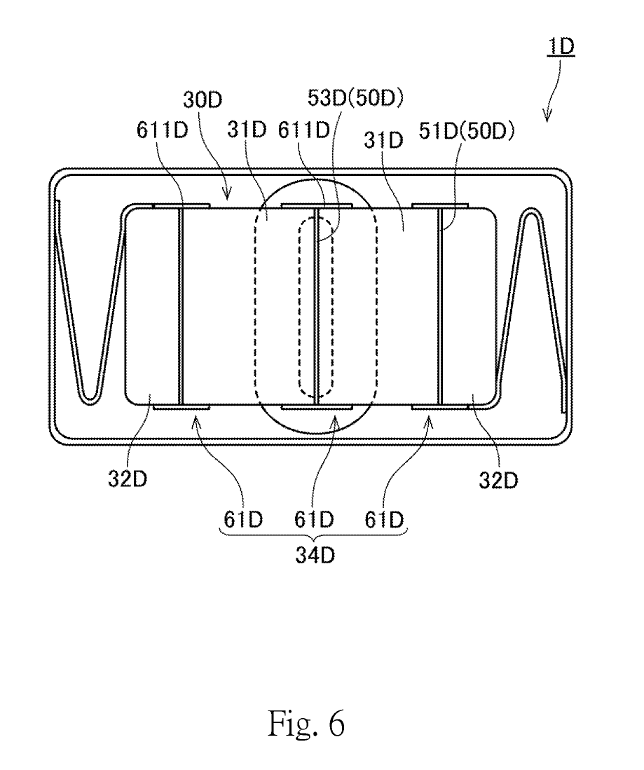

FIG. 6 is a top view of a vibration motor 1D according to a fifth preferred embodiment of the present invention with a cover portion removed therefrom. A moving body 30D of the vibration motor 1D includes two magnets 31D and a pair of brackets 32D.

The two magnets 31D are arranged adjacent to each other in the oscillation direction. In addition, the pair of brackets 32D are arranged at both ends of the two magnets 31D with respect to the oscillation direction. The moving body 30D does not include a weight.

The magnet 31D and the bracket 32D adjacent to each other in the oscillation direction are adhered and fixed to each other through an adhesive layer 50D, and the two magnets 31D adjacent to each other in the oscillation direction are adhered and fixed to each other through an adhesive layer 50D. The adhesive layers 50D include first adhesive layers 51D and a third adhesive layer 53D. Each first adhesive layer 51D is arranged between the magnet 31D and the bracket 32D to fix the magnet 31D and the bracket 32D to each other. The third adhesive layer 53D is arranged between the two magnets 31D adjacent to each other in the oscillation direction to fix the two magnets 31D to each other.

A jacket 34D is a member arranged to cover at least portions of side surfaces of the adhesive layers 50D. The jacket 34D according to the present preferred embodiment covers portions of the side surface of each first adhesive layer 51D and portions of the side surface of the third adhesive layer 53D. Specifically, the jacket 34D includes three lateral surface covering portions 61D. Each lateral surface covering portion 61D includes a pair of first plate-shaped portions 611D each of which extends in the oscillation direction and which are arranged opposite to each other with the adhesive layer 50D therebetween. Each first plate-shaped portion 611D covers the adhesive layer 50D and at least portions of the members adjacent to the adhesive layer 50D which extend in the oscillation direction.

In two of the three lateral surface covering portions 61D, each first plate-shaped portion 611D covers, on one lateral side surface of the moving body 30D, a portion of the magnet 31D which extends in the oscillation direction, the first adhesive layer 51D, and a portion of the bracket 32D which extends in the oscillation direction. That is, each of the two lateral surface covering portions 61D covers both lateral side surfaces of the first adhesive layer 51D.

Further, in the remaining one of the three lateral surface covering portions 61D, each first plate-shaped portion 611D covers, on one lateral side surface of the moving body 30D, the third adhesive layer 53D and a portion of each of the two magnets 31D which extends in the oscillation direction. That is, this lateral surface covering portion 61D covers both lateral side surfaces of the third adhesive layer 53D.

This contributes to preventing damage to the magnets 31D, the first adhesive layers 51D, and the third adhesive layer 53D when a load is applied to the moving body 30D in the vertical direction or in the lateral direction. This in turn contributes to preventing damage to the moving body 30D including the magnets 31D. Although the jacket 34D according to the present preferred embodiment includes the plurality of lateral surface covering portions 61D spaced from one another in the oscillation direction, this is not essential to the present invention. The jacket may alternatively include only one lateral surface covering portion having a large dimension in the oscillation direction.

Although the jacket 34D, which covers the moving body 30D including the plurality of magnets 31D, is made up of only the lateral surface covering portions 61D each of which covers the lateral side surfaces of the moving body 30D, this is not essential to the present invention. A jacket which covers a moving body including a plurality of magnets may be made up of only an upper/lower surface covering portion(s) arranged to cover upper and lower side surfaces of the moving body, or may include a tubular portion(s) arranged to annularly cover a side surface of the moving body. Also, a jacket which covers a moving body including a plurality of magnets may include both a lateral surface covering portion(s) arranged to cover lateral side surfaces of the moving body, and an upper/lower surface covering portion(s) arranged to cover upper and lower side surfaces of the moving body.

As in the present preferred embodiment, the moving body may include a plurality of magnets. The plurality of the magnets of the moving body contributes to increasing the Lorentz force acting on the magnet(s). This leads to stronger vibrations of the moving body.

### 6. Sixth Preferred Embodiment

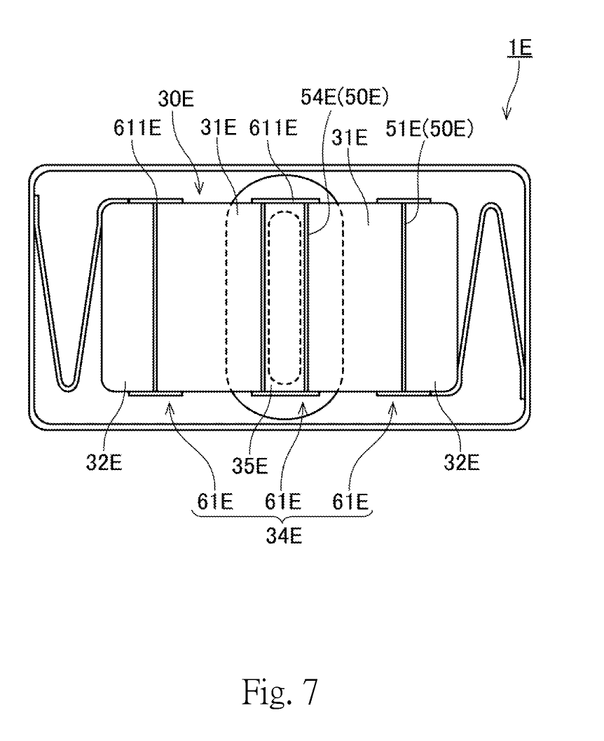

FIG. 7 is a top view of a vibration motor 1E according to a sixth preferred embodiment of the present invention with a cover portion removed therefrom. A moving body 30E of the vibration motor 1E includes two magnets 31E, a pair of brackets 32E, and one spacer 35E.

The two magnets 31E are arranged in the oscillation direction. The spacer 35E is arranged between the two magnets 31E. The pair of brackets 32E are arranged at both ends of the two magnets 31E and the spacer 35E with respect to the oscillation direction.

The magnet 31E and the bracket 32E adjacent to each other in the oscillation direction are adhered and fixed to each other through an adhesive layer 50E, and each magnet 31E and the spacer 35E, which are adjacent to each other in the oscillation direction, are adhered and fixed to each other through an adhesive layer 50E. The adhesive layers 50E include first adhesive layers 51E and fourth adhesive layers 54E. Each first adhesive layer 51E is arranged between the magnet 31E and the bracket 32E adjacent to each other in the oscillation direction to fix the magnet 31E and the bracket 32E to each other. Each fourth adhesive layer 54E is arranged between the magnet 31E and the spacer 35E adjacent to each other in the oscillation direction to fix the magnet 31E and the spacer 35E to each other.

A jacket 34E is a member arranged to cover at least portions of side surfaces of the adhesive layers 50E. The jacket 34E according to the present preferred embodiment covers portions of the side surface of each first adhesive layer 51E and portions of the side surface of each fourth adhesive layer 54E. Specifically, the jacket 34E includes three lateral surface covering portions 61E. Each lateral surface covering portion 61E includes a pair of first plate-shaped portions 611E each of which extends in the oscillation direction and which are arranged opposite to each other with the adhesive layer(s) 50E therebetween. Each first plate-shaped portion 611E covers the adhesive layer(s) 50E and at least portions of the members adjacent to each adhesive layer 50E which extend in the oscillation direction.

In two of the three lateral surface covering portions 61E, each first plate-shaped portion 611E covers, on one lateral side surface of the moving body 30E, a portion of the magnet 31E which extends in the oscillation direction, the first adhesive layer 51E, and a portion of the bracket 32E which extends in the oscillation direction. That is, each of the two lateral surface covering portions 61E covers both lateral side surfaces of the first adhesive layer 51E.

Further, in the remaining one of the three lateral surface covering portions 61E, each first plate-shaped portion 611E covers, on one lateral side surface of the moving body 30E, a portion of each of the two magnets 31E which extends in the oscillation direction, the two fourth adhesive layers 54E, and the spacer 35E. That is, this lateral surface covering portion 61E covers both lateral side surfaces of each of the two fourth adhesive layers 54E.

This contributes to preventing damage to the magnets 31E, the first adhesive layers 51E, and the fourth adhesive layers 54E when a load is applied to the moving body 30E in the vertical direction or in the lateral direction. This in turn contributes to preventing damage to the moving body 30E including the magnets 31E. Although the jacket 34E according to the present preferred embodiment includes the plurality of lateral surface covering portions 61E spaced from one another in the oscillation direction, this is not essential to the present invention. The jacket may alternatively include only one lateral surface covering portion having a large dimension in the oscillation direction.

Although the jacket 34E, which covers the moving body 30E including the plurality of magnets 31E and the spacer 35E, is made up of only the lateral surface covering portions 61E each of which covers the lateral side surfaces of the moving body 30E, this is not essential to the present invention. A jacket which covers a moving body including a plurality of magnets and a spacer may be made up of only an upper/lower surface covering portion(s) arranged to cover upper and lower side surfaces of the moving body, or may include a tubular portion(s) arranged to annularly cover a side surface of the moving body. Also, a jacket which covers a moving body including a plurality of magnets and a spacer may include both a lateral surface covering portion(s) arranged to cover lateral side surfaces of the moving body, and an upper/lower surface covering portion(s) arranged to cover upper and lower side surfaces of the moving body.

As in the present preferred embodiment, the moving body may include a plurality of magnets and a spacer arranged between the magnets. Arranging the spacer between the magnets results in magnetic flux lines passing through the spacer. This contributes to increasing the Lorentz force acting on the magnets. This leads to stronger vibrations of the moving body.

Note that, although the number of magnets included in each of the vibration motor 1D according to the fifth preferred embodiment and the vibration motor 1E according to the sixth preferred embodiment is two, a vibration motor according to another preferred embodiment of the present invention may include more than two magnets.

### 7. Seventh Preferred Embodiment

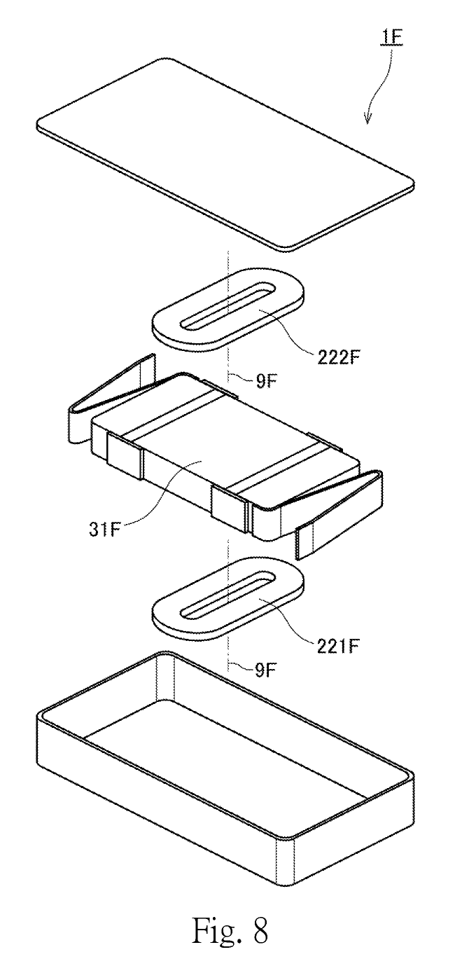

FIG. 8 is an exploded perspective view of a vibration motor 1F according to a seventh preferred embodiment of the present invention. The vibration motor 1F includes two coils 221F and 222F.

Each of the coils 221F and 222F is an air-core spiral coil formed by a conducting wire wound in a flat and spiral pattern to form a space in the center thereof. Each of the coils 221F and 222F is wound about an axis 9F extending in the vertical direction, which is substantially perpendicular to the oscillation direction.

The coils 221F and 222F are referred to as a first coil 221F and a second coil 222F, respectively. The first coil 221F is arranged below a magnet 31F. That is, the first coil 221F is arranged on one axial side of the magnet 31F. The second coil 222F is arranged above the magnet 31F. That is, the second coil 222F is arranged on another axial side of the magnet 31F.

As in the present preferred embodiment, the vibration motor may include a plurality of coils. The plurality of the coils contributes to increasing the Lorentz force acting on the magnet. This leads to stronger vibrations of a moving body.

### 8. Eighth Preferred Embodiment

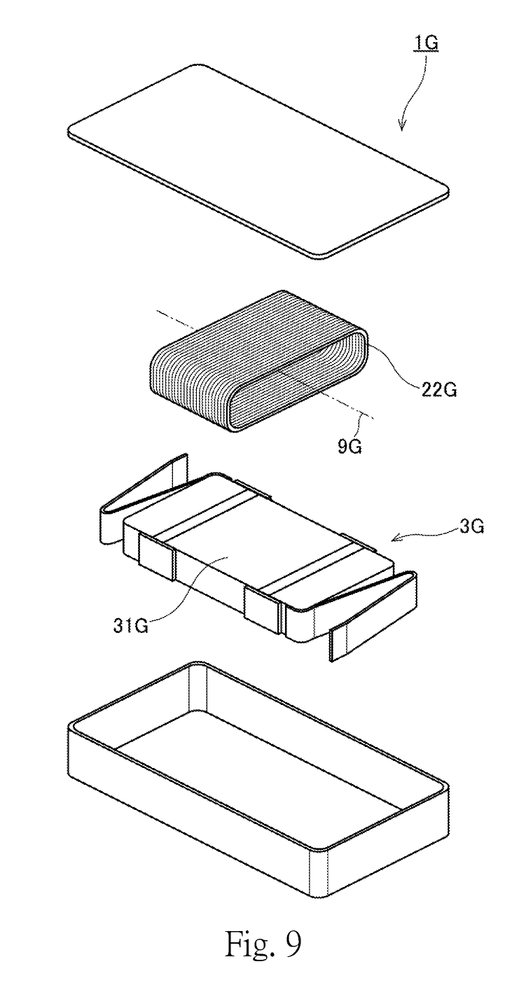

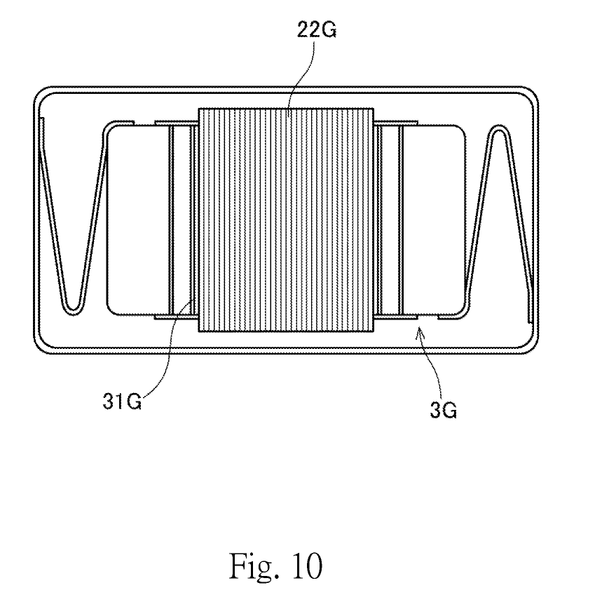

FIG. 9 is an exploded perspective view of a vibration motor 1G according to an eighth preferred embodiment of the present invention. FIG. 10 is a top view of the vibration motor 1G with a cover portion removed therefrom. As illustrated in FIGS. 9 and 10, the vibration motor 1G includes a coil 22G having at least a portion of a magnet 31G accommodated therein.

As illustrated in FIG. 9, the coil 22G is an air-core solenoid coil formed by a conducting wire wound to assume the shape of a quadrangular prism with a space in the center thereof. The coil 22G is wound about an axis 9G extending in the oscillation direction. As illustrated in FIG. 10, at least a portion of the magnet 31G is arranged inside the coil 22G.

As in the present preferred embodiment, the coil may be a solenoid coil having at least a portion of a magnet accommodated therein. In the present preferred embodiment, if an electric drive current is supplied to the coil 22G, a magnetic field generated by the coil 22G and a magnetic field generated by the magnet 31G interact to cause a Lorentz force to act on the magnet 31G. A moving portion 3G is thus caused to oscillate in the oscillation direction.

### 9. Example Modifications

Although, in each of the above-described preferred embodiments, each elastic member arranged between the stationary portion and the moving portion is a plate spring, this is not essential to the present invention. An elastic member arranged between the stationary portion and the moving portion may alternatively be a coil spring or an elastic member of another type, such as rubber.

Although, in each of the above-described preferred embodiments, each elastic member arranged between the stationary portion and the moving portion is fixed to both the stationary portion and the moving portion, this is not essential to the present invention. The elastic member may alternatively be fixed to only one of the stationary portion and the moving portion or to neither of the stationary portion and the moving portion, as long as the elastic member is arranged to support the moving portion such that the moving portion is capable of oscillating with respect to the stationary portion.

Although components of the moving portions according to the above-described preferred embodiments include only the magnet(s), the brackets, the weights, and the spacer, this is not essential to the present invention. A moving portion according to another preferred embodiment of the present invention may include a member other than the magnet(s), the brackets, the weights, and the spacer. For example, in a preferred embodiment of the present invention, a bracket and a weight may be indirectly fixed to each other with another member therebetween.

Although, in each of the above-described preferred embodiments, the weights are arranged at end portions of the moving body with respect to the oscillation direction, this is not essential to the present invention. The weight may alternatively be arranged between the magnet and the bracket or at any other desirable position.

Although, in each of the third and fourth preferred embodiments, in which the jacket is arranged to cover the upper and lower side surfaces and both lateral side surfaces of the moving body, the jacket includes the annular tubular portion(s), this is not essential to the present invention. In another preferred embodiment of the present invention, a jacket may be defined by a plurality of members which are combined to annularly cover a moving body.

Note that the detailed shape of any member may be different from the shape thereof as illustrated in the accompanying drawings of the present application. Also note that features of the above-described preferred embodiments and the modifications thereof may be combined appropriately as long as no conflict arises. For example, in each of the fifth to eighth preferred embodiments, the jacket may be modified to assume an annular shape as in each of the third and fourth preferred embodiments.

Preferred embodiments of the present invention are applicable to, for example, vibration motors.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a stationary portion including a housing and at least one coil;
a moving portion supported to be capable of oscillating in an oscillation direction with respect to the stationary portion; and
an elastic member arranged between the stationary portion and the moving portion; wherein
the at least one coil, the moving portion, and the elastic member are accommodated in the housing;
the moving portion includes:
a magnet arranged opposite to the at least one coil;
brackets arranged at both ends of the magnet with respect to the oscillation direction; and
at least one adhesive layer arranged to adhere and fix members adjacent to each other in the oscillation direction to each other; and
the moving portion further includes a jacket arranged to cover at least a portion of a side surface of the at least one adhesive layer.

2. The vibration motor according to claim 1, wherein
the jacket includes a pair of plate-shaped portions each of which extends in the oscillation direction and which are arranged opposite to each other with the adhesive layer therebetween; and
each of the pair of plate-shaped portions is arranged to cover the adhesive layer and at least a portion of a member adjacent to the adhesive layer, the portion extending in the oscillation direction.

3. The vibration motor according to claim 1, wherein
the jacket includes a tubular portion arranged to extend in the oscillation direction, and arranged to annularly cover the side surface of the adhesive layer; and
the tubular portion is arranged to cover the adhesive layer and at least a portion of a member adjacent to the adhesive layer, the portion extending in the oscillation direction.

4. The vibration motor according to claim 1, wherein
the at least one adhesive layer includes a first adhesive layer arranged between the magnet and the bracket to fix the magnet and the bracket to each other; and
the jacket is arranged to cover at least a portion of the first adhesive layer.

5. The vibration motor according to claim 4, wherein the moving portion includes a weight directly or indirectly fixed to the bracket.

6. The vibration motor according to claim 5, wherein
the weight and the bracket are arranged adjacent to each other in the oscillation direction;
the at least one adhesive layer includes a second adhesive layer arranged between the weight and the bracket to fix the weight and the bracket to each other; and
the jacket is arranged to cover at least a portion of the second adhesive layer.

7. The vibration motor according to claim 4, wherein
the moving portion includes a plurality of the magnets arranged in the oscillation direction;
the at least one adhesive layer includes a third adhesive layer arranged between two of the magnets adjacent to each other in the oscillation direction to adhere and fix the magnets to each other; and
the jacket is arranged to cover at least a portion of the third adhesive layer.

8. The vibration motor according to claim 4, wherein the at least one coil includes a first coil wound about an axis substantially perpendicular to the oscillation direction, and arranged on one axial side of the magnet.

9. The vibration motor according to claim 8, wherein the at least one coil further includes a second coil wound about the axis, and arranged on another axial side of the magnet.

10. The vibration motor according to claim 4, wherein
each of the at least one coil is an air core coil wound about an axis extending in the oscillation direction; and
the magnet is arranged inside the air core coil.

11. The vibration motor according to claim 1, wherein the moving portion includes a weight directly or indirectly fixed to the bracket.

12. The vibration motor according to claim 11, wherein
the weight and the bracket are arranged adjacent to each other in the oscillation direction;
the at least one adhesive layer includes a second adhesive layer arranged between the weight and the bracket to fix the weight and the bracket to each other; and
the jacket is arranged to cover at least a portion of the second adhesive layer.

13. The vibration motor according to claim 11, wherein the at least one coil includes a first coil wound about an axis substantially perpendicular to the oscillation direction, and arranged on one axial side of the magnet.

14. The vibration motor according to claim 13, wherein the at least one coil further includes a second coil wound about the axis, and arranged on another axial side of the magnet.

15. The vibration motor according to claim 11, wherein
each of the at least one coil is an air core coil wound about an axis extending in the oscillation direction; and
the magnet is arranged inside the air core coil.

16. The vibration motor according to claim 1, wherein
the moving portion includes a plurality of the magnets arranged in the oscillation direction;
the at least one adhesive layer includes a third adhesive layer arranged between two of the magnets adjacent to each other in the oscillation direction to adhere and fix the magnets to each other; and
the jacket is arranged to cover at least a portion of the third adhesive layer.

17. The vibration motor according to claim 1, wherein
the moving portion includes:
a plurality of the magnets arranged in the oscillation direction; and
a spacer arranged between two of the magnets adjacent to each other in the oscillation direction;
the at least one adhesive layer includes a fourth adhesive layer arranged between the magnet and the spacer adjacent to each other in the oscillation direction to adhere and fix the magnet and the spacer to each other; and
the jacket is arranged to cover at least a portion of the fourth adhesive layer.

18. The vibration motor according to claim 1, wherein the at least one coil includes a first coil wound about an axis substantially perpendicular to the oscillation direction, and arranged on one axial side of the magnet.

19. The vibration motor according to claim 18, wherein the at least one coil further includes a second coil wound about the axis, and arranged on another axial side of the magnet.

20. The vibration motor according to claim 1, wherein
each of the at least one coil is an air core coil wound about an axis extending in the oscillation direction; and
the magnet is arranged inside the air core coil.
